(19) United States
(12) Patent Application Publication
(10) Pub. No.: US 2026/0184888 A1
(43) Pub. Date: Jul. 2, 2026

(54) INORGANIC POWDER, RESIN FILLER, RESIN COMPOSITION, AND PRODUCTION METHOD FOR INORGANIC POWDER

(71) Applicant: Denka Company Limited, Tokyo (JP)

(72) Inventors: Eri KANEKO, Chuo Tokyo (JP); Kenji MIYATA, Chuo Tokyo (JP); Michiharu NAKASHIMA, Chuo Tokyo (JP)

(21) Appl. No.: 19/129,644

(22) PCT Filed: Nov. 13, 2023
(86) PCT No.: PCT/JP2023/040831

§ 371 Date: May 13, 2025

(30) Foreign Application Priority Data
Nov. 14, 2022 (JP) 2022-181480

(51) Int. Cl. C08K 3/38

(52) U.S. Cl. CPC C08K 3/38; C08K 2003/385; C08K 2201/003; C08K 2201/005; C08K 2201/006

(57) ABSTRACT

Provided are an inorganic powder that can achieve excellent fluidity when blended in a resin, a resin filler containing the inorganic powder, a resin composition containing the inorganic powder, and a production method for the inorganic powder. The inorganic powder has a Hausner ratio of 1.00 to 1.33. Provided is a resin composition containing the inorganic powder; and at least one resin selected from the group consisting of a thermoplastic resin and a thermosetting resin. Provided is a production method for an inorganic powder, the production method including: dispersing a raw material powder into a liquid containing cavitation bubbles; and recovering the raw material powder from the liquid and then drying the recovered raw material powder.

### TECHNICAL FIELD

The present invention relates to an inorganic powder, a resin filler, a resin composition, and a production method for an inorganic powder.

### BACKGROUND

Powders of inorganic metal compounds such as silica, alumina, and boron nitride are widely used as inorganic fillers for resins, taking advantage of their thermal conductivity, insulation property, etc. Generally, when inorganic fillers are blended in resins, the fluidity of resin compositions tends to decrease.

As resin compositions containing inorganic fillers with excellent fluidity, Patent Documents 1 and 2, for example, propose inorganic powders for addition to resin compositions, which have a specific particle size distribution and average circularity.
Patent Document 1: JP 2008-248007 A
Patent Document 2: JP 2008-248004 A

### SUMMARY OF THE INVENTION

However, conventional inorganic powders do not provide sufficient improvement in fluidity when resins are filled therewith. Therefore, the objective of the present invention is to provide an inorganic powder that can achieve excellent fluidity when blended in a resin, a resin filler containing the inorganic powder, a resin composition containing the inorganic powder, and a production method for the inorganic powder.

As a result of diligent investigation, the present inventors discovered that inorganic powders having a Hausner ratio, defined as the ratio of tapped density to bulk density, within a certain range can solve the above-mentioned problem, thereby completing the present invention.

That is, the present invention has the following aspects.

[1] An inorganic powder having a Hausner ratio of 1.00-1.33.

[2] The inorganic powder according to [1], wherein the inorganic powder has an average particle diameter (D50) of 30 μm or less.

[3] The inorganic powder according to [1] or [2], wherein the inorganic powder has a specific surface area of 0.3 m²/g or more.

[4] The inorganic powder according to any one of [1] to [3], wherein the inorganic powder contains at least one selected from an alumina powder, an aluminum nitride powder, a silica powder, a silicon nitride powder, a magnesium oxide powder, a titanium oxide powder, a zirconia powder, a zinc oxide powder, an aggregated boron nitride powder, a scaly boron nitride powder, and a spherical boron nitride powder.

[5] The inorganic powder according to any one of [1] to [4], wherein the inorganic powder is at least one selected from an aggregated boron nitride powder, a scaly boron nitride powder, and a spherical boron nitride powder.

[6] The inorganic powder according to [5], wherein the inorganic powder has a semi-quantitative value, calculated from an O₁ₛ peak intensity measured by X-ray photoelectron spectroscopy, of 0.6 or more.

[7] The inorganic powder according to any one of [1] to [6], wherein the inorganic powder is for filling a resin.

[8] A resin filler containing the inorganic powder according to any one of [1] to [7].

[9] A resin composition containing the inorganic powder according to any one of [1] to [8]; and at least one resin selected from a group consisted of a thermoplastic resin and a thermosetting resin.

[10] A production method for the inorganic powder according to any one of [1] to [7], the production method including:
dispersing a raw material powder into a liquid containing cavitation bubbles; and
recovering the raw material powder from the liquid and then drying the recovered raw material powder.

[11] The production method according to [10], wherein the dispersing includes loosening, with the cavitation bubbles, aggregated particles in the raw material powder.

According to the present invention, it is possible to provide an inorganic powder that can achieve excellent fluidity when blended in a resin, a resin filler containing the inorganic powder, a resin composition containing the inorganic powder, and a production method for the inorganic powder.

### DESCRIPTION OF EMBODIMENTS

Hereinafter, one embodiment of the present invention will be explained in detail. The present invention is not limited to the embodiments below and can be implemented by adding modifications, as appropriate, so long as the effects of the present invention are not compromised. When a specific explanation regarding one embodiment also applies to another embodiment, that explanation may be omitted in the other embodiment. The expression “X-Y” indicating numerical ranges in the present disclosure means “X or more and Y or less”.

The configurations and combinations thereof in each embodiment are merely examples. Additions, omissions, replacements, and other changes of the configurations can be made as appropriate within the scope not deviating from the gist of the present disclosure. The present disclosure is not limited by the embodiments. The aspects disclosed in the present specification can be combined with any other feature disclosed in the present specification.

Moreover, the term “inorganic powder” in the present disclosure refers to a powder of an inorganic metal compound. In addition, the term “powder” means an aggregate of particles.

### [Inorganic Powder]

The inorganic powder according to the present embodiment has a Hausner ratio of 1.00-1.33. The “Hausner ratio” is a ratio of tapped density to bulk density and is represented as “tapped density (g/cm³)/bulk density (g/cm³)”. By having a Hausner ratio of 1.00-1.33, the inorganic powder according to the present embodiment can provide a resin composition with excellent fluidity when a resin is filled therewith. Note that the tapped density and bulk density for determining the Hausner ratio can be measured by the following method.

### (Method of Measuring Tapped Density and Bulk Density)

First, an inorganic powder is dried at 120° C. for 5 hours. Thereafter, 5.00±0.02 g (M1) of the inorganic powder after drying is measured with a precision balance (a precision balance with a minimum weighing value of 0.001 g) and fed into a 50 mL graduated cylinder. After feeding, the volume (V1) of the inorganic powder within the graduated cylinder is visually measured (to one decimal point). Next, the graduated cylinder is lifted and dropped 500 times from a height of 3.5 cm. At this time, the graduated cylinder is dropped onto a rubber mat (with a thickness of 40 mm) so that the impact on the graduated cylinder is the same each time. After being dropped 500 times, the volume (V2) of the inorganic powder within the graduated cylinder is visually measured (to one decimal point). The bulk density and tapped density of the inorganic powder are calculated from the following formulas (1) and (2). The bulk density and tapped density are calculated to two decimal points, rounding off the third decimal point. Moreover, the bulk density and tapped density are calculated in “g/cm³”, wherein 1 mL in the graduated cylinder is 1 cm³. Note that the above-mentioned tapped density and bulk density are measured under conditions of a temperature of 21-25° C. and a humidity of 50%±4%.

$$Bulk density ( g / {cm}^{3} ) : inorganic powder mass ( M 1 ) / V 1 \qquad ( 1 )$$

$$Tapped density ( g / {cm}^{3} ) : inorganic powder mass ( M 1 ) / V 2 \qquad ( 2 )$$

As mentioned above, the inorganic powder according to the present embodiment has a Hausner ratio of 1.00-1.33. In one embodiment, a preferable range of the Hausner ratio of the inorganic powder may be 1.00-1.11, 1.12-1.18, 1.19-1.25, or 1.26-1.33.

Note that depending on the type, etc. of the inorganic powder, a lower tapping density usually results in a higher Hausner ratio, likely to exceed 1.33. That is, an inorganic powder having a small tapping density has a large volume and low bulk density, so the inorganic powder is likely to have a Hausner ratio exceeding 1.33. Even if the tapped density is low, the inorganic powder according to the present embodiment can have a Hausner ratio in the range of 1.00-1.33. In one embodiment, the inorganic powder may have a tapped density of, for example, 2.30 g/cm³ or less, 2.00 g/cm³ or less, 1.70 g/cm³ or less, 1.50 g/cm³ or less, 1.30 g/cm³ or less, or 1.00 g/cm³ or less. Even with such tapped density, the Hausner ratio tends to be within the above range, so the fluidity is likely to be improved. The lower limit of the tapped density of the inorganic powder is not particularly limited, but may be, for example, 0.10 g/cm³ or more, 0.20 g/cm³ or more, or 0.30 g/cm³ or more. For the tapped density of the inorganic powder according to the present embodiment, any combination of the above-mentioned preferred upper and lower limits may be adopted so long as the Hausner ratio is within the range of 1.00-1.33.

Moreover, depending on the type, etc. of the inorganic powder, as mentioned above, a lower bulk density usually results in a higher Hausner ratio, likely to exceed 1.33. Even if the bulk density is low, the inorganic powder according to the present embodiment can have a Hausner ratio in the range of 1.00-1.33. In one embodiment, the inorganic powder may have a bulk density of, for example, 1.60 g/cm³ or less, 1.40 g/cm³ or less, 1.20 g/cm³ or less, 1.00 g/cm³ or less, or 0.80 g/cm³ or less. Even with such bulk densities, the Hausner ratio tends to be within the above range, so the fluidity is likely to be improved. The lower limit of the bulk density of the inorganic powder is not particularly limited, but may be, for example, 0.05 g/cm³ or more, 0.10 g/cm³ or more, or 0.20 g/cm³ or more. For the bulk density of the inorganic powder according to the present embodiment, any combination of the above-mentioned preferred upper and lower limits may be adopted so long as the Hausner ratio is within the range of 1.00-1.33. It is particularly preferable that the inorganic powder of the present embodiment has a tapped density of 1.00 g/cm³ or less and a bulk density of 1.00 g/cm³ or less.

Accordingly, an inorganic powder with a small difference between the tapped density and bulk density is readily prepared, for example, by a production method including dispersing a raw material powder of the inorganic powder into a liquid containing cavitation bubbles, and thereafter recovering the raw material powder from the liquid and then drying the recovered raw material powder. The production method for the inorganic powder will be described below. The production method for the inorganic powder according to the present embodiment is particularly preferably applicable to an inorganic powder having a tapped density of 1.00 g/cm³ or less and a bulk density of 1.00 g/cm³ or less.

### <Average Particle Diameter (D50)>

The inorganic powder according to the present embodiment preferably has an average particle diameter (D50) of 30 μm or less. The average particle diameter (D50) of the inorganic powder refers to a volume-based cumulative diameter (D50) evaluated by using a laser diffraction/scattering method after performing a specific dispersion process, for example, a homogenization process. Moreover, “volume-based cumulative diameter (D50)” means a particle diameter in which the cumulative value corresponds to 50% in a volume-based cumulative particle size distribution measured by using a laser diffraction/scattering method. The cumulative particle size distribution is expressed as a distribution curve in which the horizontal axis represents the particle diameter (μm) and the vertical axis represents the cumulative value (%).

Normally, when the average particle diameter (D50) (hereinafter sometimes referred to as “D50”) of the inorganic powders is small, the Hausner ratio is likely to be outside the range of the present embodiment. However, according to the present embodiment, even if the D50 is small, the Hausner ratio is likely to be in the range of 1.00-1.33. Therefore, even if the D50 is 30 μm or less, the fluidity is likely to be improved. In one embodiment, the inorganic powder may have a D50 of 30 μm or less, 27 μm or less, 25 μm or less, 22 μm or less, 20 μm or less, 17 μm or less, 15 μm or less, 12 μm or less, or 9 μm or less. Even if the D50 is equal to or less than the above-mentioned upper limit, the Hausner ratio tends to be 1.00-1.33, so the inorganic powder is likely to have excellent fluidity. The lower limit of the D50 of the inorganic powder is not particularly limited, but may be, for example, 0.05 μm or more, 0.08 μm or more, 0.12 μm or more, 0.15 μm or more, 0.17 μm or more, 0.20 μm or more, 0.22 μm or more, or 0.25 μm or more. For the D50 of the inorganic powder according to the present embodiment, any combination of the above-mentioned of the above-mentioned preferred upper and lower limits may be adopted so long as the Hausner ratio is within the range of 1.00-1.33.

### <Specific Surface Area>

Normally, when the specific surface area of the inorganic powder is large, the Hausner ratio is likely to be outside the range of the present embodiment. However, according to the present embodiment, even if the specific surface area is large, the Hausner ratio is likely to be in the range of 1.00-1.33. Therefore, even if the specific surface area is large, the fluidity is likely to be improved. In one embodiment, the inorganic powder may have a specific surface area of 0.1 m²/g or more, 0.2 m²/g or more, 0.3 m²/g or more, 0.4 m²/g or more, 0.5 m²/g or more, 0.6 m²/g or more, 0.7 m²/g or more, 0.8 m²/g or more, 0.9 m²/g or more, or 1.0 m²/g or more. Even if the specific surface area is equal to or more than the above-mentioned lower limit, the inorganic powder is likely to have excellent fluidity. The upper limit of the specific surface area of the inorganic powder is not particularly limited, but may be, for example, 35 m²/g or less, 32 m²/g or less, 30 m²/g or less, 27 m²/g or less, 25 m²/g or less, 22 m²/g or less, 20 m²/g or less, 17 m²/g or less, or 15 m²/g or less. For the specific surface area of the inorganic powder according to the present embodiment, any combination of the above-mentioned of the above-mentioned preferred upper and lower limits may be adopted so long as the Hausner ratio is within the range of 1.00-1.33.

Note that in the present disclosure, the specific surface area of the inorganic powder can be measured with the BET multiple-point method using nitrogen gas, in accordance with JIS Z 8830:2013.

The inorganic powder according to the present embodiment preferably contains at least one selected from an alumina powder, an aluminum nitride powder, a silica powder, a silicon nitride powder, a magnesium oxide powder, a titanium oxide powder, a zirconia powder, a zinc oxide powder, an aggregated boron nitride powder, a scaly boron nitride powder, and a spherical boron nitride powder, more preferably contains at least one selected from an alumina powder, an aluminum nitride powder, a silica powder, a silicon nitride powder, an aggregated boron nitride powder, a scaly boron nitride powder, and a spherical boron nitride powder, and even more preferably contains at least one selected from an alumina powder, a silica powder, an aggregated boron nitride powder, a scaly boron nitride powder, and a spherical boron nitride powder. In one embodiment, the inorganic powder may contain only one type of the above-mentioned powders, or may be a mixed powder containing two or more types. Note that when the inorganic powder is a mixed powder, the blending ratio of each powder can be set arbitrarily.

The alumina powder, aluminum nitride powder, silica powder, silicon nitride powder, magnesium oxide powder, titanium oxide powder, zirconia powder, and zinc oxide powder are not particularly limited in shape and may be spherical or irregularly shaped. However, from the perspective of fluidity and low viscosity during filling, the spherical shape is preferred.

In one embodiment, the inorganic powder is preferably at least one powder selected from the aggregated boron nitride powder, scaly boron nitride powder, and spherical boron nitride powder, and is more preferably the scaly boron nitride powder or spherical boron nitride powder.

The boron nitride powder has lubricity, high thermal conductivity, and insulation properties, etc., and is widely used in solid lubricants, mold release agents such as molten gases and aluminum, fillers for heat dissipating materials, and the like. When the inorganic powder according to the present embodiment is at least one powder selected from the above-mentioned aggregated boron nitride powder, scaly boron nitride powder, and spherical boron nitride powder, it is easier to provide solid lubricants, mold release agents, and fillers for heat dissipating materials with better fluidity than before. In the present disclosure, “aggregated boron nitride powder” refers to a powder in which the primary particles are scale-like and hexagonal boron nitride is aggregated to form a lump.

In the present disclosure, “spherical powder” means that when observed at a 10,000× magnification using a scanning electron microscope, a circular or rounded particle shape is observed. In one embodiment, the spherical boron nitride powder may have an average circularity of 0.70 or more, 0.75 or more, 0.80 or more, or 0.87 or more. Note that “average circularity” can be calculated by the following method.

### (Method for Measuring Average Circularity)

Image analysis software (for example, product name: “MacView” manufactured by Mountech Co., Ltd.) is used to perform image analysis on an image of a powder (magnification: 10,000×, image resolution: 1280×1024 pixels), captured by using a scanning electron microscope (SEM), to calculate the projected area(S) and perimeter (L) of one particle. The circularity is calculated by substituting the projected area(S) and perimeter (L) into the following formula (3). The average value of the circularities determined for 200 arbitrary particles is defined as the average circularity.

$$Circularity = 4 π S / {L}^{2} \qquad ( 3 )$$

In one embodiment, the inorganic powder may have a semi-quantitative value, calculated from the O₁ₛ peak intensity measured by X-ray photoelectron spectroscopy (hereinafter, sometimes referred to as “O₁ₛ semi-quantitative value), of preferably 0.6 or more, more preferably 0.65 or more, and even more preferably 0.7 or more. In the present disclosure, “semi-quantitative value calculated from an O₁ₛ peak intensity measured by X-ray photoelectron spectroscopy” refers to a semi-quantitative value obtained by measuring an inorganic powder using an X-ray photoelectron spectroscopy device (e.g., product name: K-Alpha type X-ray photoelectron spectrometer manufactured by Thermo Fisher Scientific Inc., AI X-ray source with monochromator; measurement region: 400×200 μm) to obtain a spectrum, removing the background of the spectrum with the Shirley method, and performing calculation from the O₁ₛ peak intensity. More specifically, “O₁ₛ peak intensity” can be the value of the O₁ₛ peak area in the inorganic powder, measured according to the manual of the X-ray photoelectron spectrometer. Herein, “Shirley method” refers to a method for determining a shape of a subtracted background with the assumption that there is no energy dependency with respect to background-causing inelastically scattered electrons, and further, that the number of electrons that scatter inelastically is proportional to a peak intensity.

### (Use)

The inorganic powder according to the present embodiment can provide a resin composition having excellent fluidity. Therefore, the inorganic powder can be preferably used as a resin filler.

### <Resin Filler>

The resin filler according to the present embodiment contains the above-mentioned inorganic powder. From the perspective of obtaining a resin composition having more excellent fluidity, the resin filler may be constituted only by the above-mentioned inorganic powder. Note that the resins in which the resin filler according to the present embodiment can be blended are not particularly limited, and the resin filler can be blended in conventionally known thermosetting resins and thermoplastic resins.

### [Production Method for Inorganic Powder]

The production method for the inorganic powder according to the present embodiment includes dispersing a raw material powder into a liquid containing cavitation bubbles (step (I)); and recovering the raw material powder from the liquid and then drying the recovered raw material powder (step (II)). According to the production method according to the present embodiment, it is possible to efficiently produce an inorganic powder having a Hausner ratio of 1.00-1.33.

### <Step (I)>

The production method according to the present embodiment includes dispersing a raw material powder into a liquid containing cavitation bubbles (step (I)). Herein, “cavitation bubbles” means bubbles that are generated by liquid vaporization when a liquid reaches a low-pressure state.

Examples of methods for dispersing a raw material powder into a liquid containing cavitation bubbles include a method for feeding a raw material powder into a liquid containing cavitation bubbles and then mechanically stirring, a method for utilizing cavitation bubbles to disperse a raw material powder into a liquid, and the like.

When a raw material powder is dispersed in a liquid containing cavitation bubbles, the bubbles generated by cavitation expand and contract due to the pressure difference, and this force breaks down the aggregated particles (including secondary particles) in the raw material powder. As a result, the proportion of the primary particles in the raw material powder is likely to increase. By recovering and drying such raw material powder with the method described below, an inorganic powder having a small ratio of tapped density to bulk density, that is, a Hausner ratio in the range of 1.00-1.33, can be obtained. In the production method according to the present embodiment, step (I) preferably includes loosening aggregated particles in a raw material powder using cavitation bubbles (that is, breaking down the aggregated particles). The above-mentioned loosening step includes breaking down the aggregated particles to their primary particles.

Note that step (I) increases the existence ratio of hydroxyl groups on the particle surface, and the like, which makes the surface state of the particles more susceptible to change. This is also considered to be one of the reasons that an inorganic powder having a small Hausner ratio can be obtained.

### (Raw Material Powder)

The raw material powder is not particularly limited. An inorganic powder prepared by any method can be employed as a raw material powder. In step (I), from the perspective of efficiently breaking down the aggregated particles, the raw material powder has an average particle diameter (D50) of preferably 0.05-30 μm, and more preferably 0.5-25 μm. Moreover, the raw material powder may have a specific surface area of 1-30 m²/g or 1-15 m²/g.

The raw material powder has a Hausner ratio of preferably 1.35-3.00, and more preferably 1.50-2.50. Using a raw material powder having a Hausner ratio within the above-mentioned ranges makes it easier to obtain the inorganic powder according to the present embodiment.

### (Cavitation Bubbles)

Examples of methods of preparing a liquid containing cavitation bubbles include a method of depressurizing a liquid, a method of utilizing ultrasonic waves, a method of utilizing fluid dynamics, and the like. By using commercially available devices, it is possible to prepare a liquid containing cavitation bubbles with these methods. In one embodiment, the method of utilizing fluid dynamics may be employed. For example, using a commercially available powder suction continuous dissolution and dispersion device to prepare a liquid containing cavitation bubbles is preferable, and generating cavitation bubbles while circulating the liquid is particularly preferable.

Powder suction continuous dissolution and dispersion devices generally have a mechanism for generating flow velocity by using stirring blades. In one embodiment, stirring blades have a rotation speed of preferably 2,000-10,000 rpm, more preferably 4,000-9,000 rpm, even more preferably 4,500-8,000 rpm, still even more preferably 5,000-8,000 rpm, and particularly preferably 6,000-7,200 rpm.

In one embodiment, step (I) preferably includes generating cavitation bubbles in a liquid. That is, dispersing a raw material powder in the liquid while generating cavitation bubbles makes it easier to break down aggregated particles in the raw material powder.

In one embodiment, the process for generating cavitation bubbles is preferably performed 50 times or more, more preferably 100 times or more, and even more preferably 150 times or more, the number of times the cavitation process is performed being calculated from the rotation speed (rpm) of the stirring blades of the device and the discharge amount.

### (Liquid)

In the production method according to the present embodiment, the liquid used to disperse the raw material powder is not particularly limited as long as it has the effects of the present invention. From the perspective of ease of drying after processing, the liquid may be a liquid consisting only of an organic solvent such as ethanol or may be a mixed solution of water and an organic solvent.

In the case of a mixed solution of water and an inorganic solvent, the water in the mixed solution may have a content of preferably 80 mass % or more, more preferably 90 mass % or more, and even more preferably 95 mass % or more. In one embodiment, it is particularly preferred that the above-mentioned liquid is a liquid consisting only of water.

From the perspective of effectively generating cavitation in a liquid and suppressing liquid volatilization, the liquid temperature in step (I) is preferably 10-60° C., and more preferably 20-40° C.

The proportion of the raw material powder dispersed in the liquid is preferably 5-30 mass %, more preferably 5-20 mass %, and even more preferably 5-15 mass % with respect to the total amount of the liquid and raw material powder (100 mass %). In one embodiment, the proportion of the raw material powder may be 5-10 mass % or 8-10 mass %.

The time for performing step (I) is not particularly limited as long as it has the effects of the present invention. From the perspective of easily enhancing the efficiency of recovering the broken-down powder or of suppressing variability in the breaking down of the processed powder, the time of step (I) may be extended. In one embodiment, step (I) may be 5 minutes or more and 24 hours or less, 5 minutes or more and 20 hours or less, or 5 minutes or more and 10 hours or less.

### <Step (II)>

Step (II) is a step of, after step (I), recovering the raw material powder from the liquid and then drying the recovered raw material powder. Examples of methods of recovering the raw material powder from the liquid include filtration process (such as decompressing filtration and vacuum filtration), centrifugal separation, and the like.

Examples of methods of drying the recovered raw material powder include high-temperature air drying, decompression drying, and the like.

In one embodiment, the drying temperature of the raw material powder is preferably 80-150° C., and more preferably 100-120° C. Moreover, the drying time is preferably 2-24 hours and more preferably 5-12 hours.

The production method according to the present embodiment may include steps other than the above-mentioned steps (I) and (II) (other steps). Examples of the other steps include loosening the inorganic powder, and the like.

### [Resin Composition]

The resin composition according to the present embodiment contains the above-mentioned inorganic powder; and at least one resin selected from the group consisting of a thermoplastic resin and a thermosetting resin.

The proportion of the inorganic powder in the resin composition is not particularly limited and may be adjusted, as appropriate, according to the objectives. For example, the proportion may be in the range of 1-99 mass % or in the range of 5-80 mass % with respect to the total mass of the resin composition.

### <Resin>

The resin composition according to the present embodiment contains at least one resin selected from a thermoplastic resin and a thermosetting resin. More specifically, examples include polyethylene resins; polypropylene resins; epoxy resins; silicone resins; phenolic resins; melamine resins; urea resins; unsaturated polyester resins; fluororesins; polyamide-based resins such as polyimide resins, polyamide-imide resins, and polyether imide resins; polyester-based resins such as polybutylene terephthalate resins and polyethylene terephthalate resins; polyphenylene sulfide resins; wholly aromatic polyester resins; polysulfone resins; liquid crystal polymer resins; polyethersulfone resins; polycarbonate resins; maleimide modified resins; ABS resins; acrylonitrile-acrylic rubber-styrene (AAS) resins; acrylonitrile-ethylene-propylene-diene rubber-styrene (AES) resins; hydrocarbon-based elastomer resins; polyphenylene ether resins; aromatic polyene-based resins; and the like. The foregoing may be used alone or as a combination of two or more.

The resin composition can have other additives blended therein to the extent that the other additives do not hinder the effects of the present invention. Examples of the other additives include rubber substances such as silicone rubbers, polysulfide rubbers, acrylic rubbers, butadiene-based rubbers, styrene-based block copolymers, and saturated elastomers; resinous substances such as silicone resins; resins in which epoxy resins or phenol resins are partially or wholly modified by amino silicone, epoxy silicone, alkoxy silicone, and the like; flame retardant promoters such as Sb₂O₃, Sb₂O₄, and Sb₂O₅; flame retardants such as halogenated epoxy resins and phosphorus compounds; colorants such as carbon black, iron oxide, dyes, and pigments; and the like. The foregoing may be used alone or as a combination of two or more.

### <Production Method of Resin Composition>

The production method for a resin composition is not particularly limited, and the resin composition may be produced by stirring, dissolving, mixing, or dispersing prescribed amounts of each material. The devices for mixing, stirring, dispersing, etc., these mixtures are not particularly limited, and it is possible to use a mortar machine, a three-roll mill, a ball mill, a planetary mixer, etc., provided with a stirring and heating device. The foregoing devices may also be used in combination, as appropriate.

### EXAMPLES

The present invention shall be explained still more specifically by referring to the examples below, but interpretation of the present invention is not limited by these examples.

### (Raw Material Powder)

As a raw material powder, the following inorganic metal compounds were used.

TABLE 1

| | | RAW MATERIAL | RAW MATERIAL | RAW MATERIAL | RAW MATERIAL |
|---|---|---|---|---|---|
| | | POWDER 1 | POWDER 2 | POWDER 3 | POWDER 4 |
| TYPE | (—) | SPHERICAL | SCALY BORON | SPHERICAL | SPHERICAL |
| | | BORON | NITRIDE POWDER | ALUMINA POWDER | SILICA POWDER |
| | | NITRIDE POWDER | | | |
| AVERAGE | (μm) | 0.62 | 5.0 | 0.30 | 0.40 |
| PARTICLE | | | | | |
| DIAMETER (D50) | | | | | |
| SPECIFIC SURFACE | (m²/g) | 13.0 | 9.0 | 10.8 | 11.2 |
| AREA | | | | | |
| BULK DENSITY | (g/cm³) | 0.19 | 0.18 | 0.35 | 0.24 |
| TAPPED DENSITY | (g/cm³) | 0.28 | 0.45 | 0.71 | 0.54 |
| HAUSNER RATIO | (—) | 1.47 | 1.63 | 2.05 | 2.22 |
| VISCOSITY (ρ1) OF | (Pa · s) | 846 | 163 | 64 | 9 |
| RESIN | SHEAR RATE 0.1 [1/s] | | | | |
| COMPOSITION | | | | | |

In Table 1, the average particle diameter (D50), specific surface area, bulk density, and tapped density of the raw material powders, as well as the viscosity (ρ1) of the resin compositions, are values measured under the same conditions as the inorganic powders described below.

### Example 1

The raw material powder 1 (10 mass %) was dispersed in ion-exchanged water, in which cavitation bubbles were generated using a powder suction continuous dissolution and dispersion device (product name: JET PASTER®, model number: JPSS, manufactured by Nihon Spindle Manufacturing Co., Ltd.) (step (I)). Note that the cavitation bubbles in the ion-exchanged water were generated while rotating the stirring blades of the above-mentioned device at 7,200 rpm. After performing step (I) for 60 minutes, a filtration process was performed to recover the raw material powder. Thereafter, the recovered raw material powder was dried at 120° C. for 5 hours to obtain the inorganic powder (spherical boron nitride powder) of Example 1.

With respect to the obtained inorganic powder, the average particle diameter (D50), specific surface area (BET specific surface area), O₁ₛ semi-quantitative value, bulk density, and tapped density were measured under the following conditions. Moreover, the fluidity of the resin compositions containing the inorganic powder was evaluated under the following conditions. The results are shown in Table 2.

### (Measurement of Bulk Density and Tapped Density)

The bulk density and tapped density of the inorganic powders was measured by the method shown below.

First, an inorganic powder was dried at 120° C. for 5 hours. Thereafter, 5.00±0.02 g (M1) of the inorganic powder after drying was measured with a precision balance (a precision balance with a minimum weighing value of 0.001 g) and fed into a 50 mL graduated cylinder. After feeding, the volume (V1) of the inorganic powder within the graduated cylinder was visually measured (to one decimal point). Next, the graduated cylinder was lifted and dropped 500 times from a height of 3.5 cm. At this time, the graduated cylinder was dropped onto a rubber mat (with a thickness of 40 mm) so that the impact on the graduated cylinder was the same each time. After being dropped 500 times, the volume (V2) of the inorganic powder within the graduated cylinder was visually measured (to one decimal point). The bulk density and tapped density of the inorganic powder were calculated from the following formulas (1) and (2). The bulk density and tapped density were calculated to two decimal points, rounding off the third decimal point. Moreover, the bulk density and tapped density were calculated in “g/cm³”, with 1 mL in the graduated cylinder being 1 cm³. Note that the above-mentioned tapped density and bulk density were measured under conditions of a temperature of 23° C. and a humidity of 50%.

$$Tapped density ( g / {cm}^{3} ) : inorganic powder mass ( M 1 ) / V 1 \qquad ( 1 )$$

$$Bulk density ( g / {cm}^{3} ) : inorganic powder mass ( M 1 ) / V 2 \qquad ( 2 )$$

Based on the above results, the Hausner ratio (tapped density/bulk density) was calculated.

### (Method for Measuring Average Particle Diameter (D50))

After 0.01 g of the inorganic powder was dispersed in 80 mL of ethanol, a dispersing process was performed with a homogenizer, and the volume-based particle size distribution was measured with a laser diffraction/scattering-method particle size distribution measuring device (product name: LS-13 320 manufactured by Beckman-Coulter, Inc.). At this time, 1.359 was used as the refractive index of the ethanol. An average particle diameter (D50) (μm) was determined from the obtained frequency distribution of particle sizes.

### (Method for Measuring Specific Surface Area)

The BET specific surface area of the inorganic powder was measured with the BET multiple-point method using nitrogen gas, in accordance with JIS Z 8830:2013.

### (Measurement of O₁ₛ Semi-Quantitative Value)

A semi-quantitative value (that is, O₁ₛ peak area) was calculated from an O₁ₛ peak intensity by using an X-ray photoelectron spectroscopy device (product name: K-Alpha type X-ray photoelectron spectrometer manufactured by Thermo Fisher Scientific Inc., AI X-ray source with monochromator; measurement region: 400×200 μm) to measure a spectrum according to the manual, and then removing the background of the spectrum with the Shirley method.

The fluidity of the resin composition containing the inorganic powder was evaluated with the ratio of the shear viscosity of the raw material powder and the inorganic powder (the ratio of the shear viscosities before and after the cavitation process). Specifically, after the resin composition was prepared with the following method, the ratio of the viscosity at time of shear rate 0.1 (1/s) of the obtained resin composition was evaluated.

### (Preparation of Resin Composition)

An epoxy resin (product name: “YDF-8170C” manufactured by NIPPON STEEL Chemical & Material Co., Ltd.) had a dispersing agent (product name: “DISPERBYK-111” manufactured by BYK Chemie Japan, 0.3 mass %), an SC agent (product name: “3-Glycidyloxypropyltrimethoxysilane” manufactured by Tokyo Chemical Industry, Ltd., 1 mass %), and a raw material powder (15 mass %) added thereto, and the obtained mixture was kneaded for 3 minutes at room temperature, a revolution speed of 2,000 rpm, and a rotation speed of 800 rpm using a hybrid mixer (product name: “Awatori Rentaro® AR-250” manufactured by Thinky Corporation). Thereafter, the mixture was kneaded twice using a three-roll mill (product name: “BR-150VIII” manufactured by AIMEX CO., LTD., gap: 10 μm, finishing roll rotation speed: 60 rpm) to obtain a resin composition for evaluation (a resin composition containing the raw material powder (before the cavitation process)). The viscosity (ρ1) of the obtained resin composition was measured at the time of shear rate 0.1 (1/s) when the shear rate was varied, at 25° C., from 0.01 (1/s) to 100 (1/s) and then back from 100 (1/s) to 0.01 (1/s) to measure the viscosity using a rheometer (product name: “MCR92” manufactured by Anto Paar GmbH”). The results are shown in Table 1. Next, a resin composition containing the inorganic powder (15 mass %) according to the Examples and Comparative Examples was prepared with the same method as above, the viscosity at the time of shear rate 0.1 (1/s) was measured to calculate the ratio with respect to ρ1, and then evaluation was performed in accordance with the evaluation criteria below. Among the evaluation criteria below, a B rating or higher was considered to be a pass (indicating improvement in fluidity when a resin is filled therewith). The results are shown in Table 2.

### (Evaluation Criteria)

A: The ratio with respect to ρ1 is 0.01 or less.
B: The ratio with respect to ρ1 is more than 0.01 and 0.25 or less.
C: The ratio with respect to ρ1 is more than 0.25 and 0.5 or less.
D: The ratio with respect to ρ1 is more than 0.5.

### Examples 2-7 and Comparative Examples 1-4

The inorganic powders were produced with the same method as in Example 1, except that the types of the raw material powders and the production conditions were configured as shown in Table 2. Comparative Examples 1-4 involved stirring and dispersing the raw material powder in a liquid that does not contain cavitation bubbles, and thereafter recovering the raw material powder by filtering and then drying the recovered raw material powder. With respect to the obtained inorganic powders in the Examples, the average particle diameter (D50), specific surface area, bulk density, and tapped density were measured with the same method as in Example 1, and the fluidity evaluation of the resin compositions containing the inorganic powders was performed. In addition, the O₁ₛ semi-quantitative value was measured with the same method as in Examples 2-5 and Comparative Examples 1-2. The results are shown in Table 2.

In Tables 1-2, the notation “-” indicates that a device was not used or that the measurement was not performed.

TABLE 2

| | | | | EX | | EX. | EX | EX. | EX. | EX. |
|---|---|---|---|---|---|---|---|---|---|---|
| | | | | 1 | Ex. | 2 | 3 | 4 | 5 | 6 |
| PRO- | USED RAW | | | RAW | RAW | RAW | RAW | RAW | RAW | RAW |
| DUCTION | MATRIAL | | | MATE- | MATE- | MATE- | MATE- | MATE- | MATE- | MATE- |
| CONDI- | | | | RIAL | RIAL | RIAL | RIAL | RIAL | RIAL | RIAL |
| TIONS | | | | POW- | POW- | POW- | POW- | POW- | POW- | POW- |
| | | | | DER 1 | DER 1 | DER 1 | DER 1 | DER 1 | DER 2 | DER 3 |
| | DISPERSED | | | ION- | ION- | ION- | ION- | ION- | ION- | ION- |
| | SOLUTION | | | EX- | EX- | EX- | EX- | EX- | EX- | EX- |
| | | | | CHANGED | CHANGED | CHANGED | CHANGED | CHANGED | CHANGED | CHANGED |
| | | | | WATER | WATER | WATER | WATER | WATER | WATER | WATER |
| | STEP | PRESENCE OR | | PRESENT | | | | | | |
| | (I) | ABSENCE OF | | | | | | | | |
| | | CAVITATION | | | | | | | | |
| | | BUBBLES | | | | | | | | |
| | | DEVICE | (—) | POWDER SUCTION CONTINUOUS | | | | | | |
| | | | | DISSOLUTION AND DISPERSION DEVICE | | | | | | |
| | | ROTA- | (rpm) | 7,200 | 7,200 | 7,200 | 7,200 | 6,000 | 7,200 | 7,200 |
| | | TION | | | | | | | | |
| | | SPEED | | | | | | | | |
| | | PRO- | (min) | 60 | 60 | 30 | 10 | 60 | 30 | 60 |
| | | CESSING | | | | | | | | |
| | | TIME | | | | | | | | |
| | STEP | DRYING | (° C.) | 120 | 120 | 120 | 120 | 120 | 120 | 120 |
| | (II) | TEMPER- | | | | | | | | |
| | | ATURE | | | | | | | | |
| | | DRYING | (hr) | 6 | 12 | 12 | 12 | 12 | 5 | 5 |
| | | TIME | | | | | | | | |

| | | | | | | | | | |
|---|---|---|---|---|---|---|---|---|---|
| INOR- | BULK | (g/cm³) | 0.56 | 0.53 | 0.56 | 0.53 | 0.59 | 0.37 | 0.65 |
| GANIC | DENSITY | | | | | | | | |
| POWDER | TAPPED | (g/cm³) | 0.59 | 0.57 | 0.63 | 0.63 | 0.63 | 0.45 | 0.79 |
| PRO- | DENSITY | | | | | | | | |
| PERTIES | HAUSNER | (—) | 1.06 | 1.07 | 1.13 | 1.19 | 1.07 | 1.23 | 1.22 |
| | RATIO | | | | | | | | |
| | AVERAGE | (μm) | 0.50 | 0.50 | 0.50 | 0.50 | 0.50 | 0.4 | 0.30 |
| | PARTICLE | | | | | | | | |
| | DIAMETER | | | | | | | | |
| | (D50) | | | | | | | | |
| | SPECIFIC | (m²/g) | 14.0 | 14.0 | 14.0 | 13.0 | 13.0 | 9.0 | 10.8 |
| | SURFACE | | | | | | | | |
| | AREA | | | | | | | | |
| | O_{1S} SEMI- | (—) | 1.4 | 1.4 | 0.9 | 0.7 | 1.1 | 2.2 | — |
| | QUANTI- | | | | | | | | |
| | TATIVE | | | | | | | | |
| | VALUE | | | | | | | | |

| | | | | | | | | |
|---|---|---|---|---|---|---|---|---|
| FLUIDITY EVALUATION | (—) | A | A | A | B | B | A | A |

| | | | COMP. | COMP. | COMP. | COMP |
|---|---|---|---|---|---|---|
| | | EX | EX. | EX | EX. | EX. |
| | | 7 | 1 | 2 | 3 | 4 |
| PRO- | USED RAW | RAW | RAW | RAW | RAW | RAW |
| DUCTION | MATRIAL | MATE- | MATE- | MATE- | MATE- | MATE- |
| CONDI- | | RIAL | RIAL | RIAL | RIAL | RIAL |
| TIONS | | POW- | POW- | POW- | POW- | POW- |
| | | DER 4 | DER 1 | DER 2 | DER 3 | DER 4 |
| | DISPERSED | ION- | ION- | ION- | ION- | ION- |
| | SOLUTION | EX- | EX- | EX- | EX- | EX- |
| | | CHANGED | CHANGED | CHANGED | CHANGED | CHANGED |
| | | WATER | WATER | WATER | WATER | WATER |

| STEP | PRESENCE OR | | PRESENT | ABSENT | | | |
|---|---|---|---|---|---|---|---|
| (I) | ABSENCE OF | | | | | | |
| | CAVITATION | | | | | | |
| | BUBBLES | | | | | | |
| | DEVICE | (—) | POWDER SUCTION | — | — | — | — |
| | | | CONTINUOUS | | | | |
| | | | DISSOLUTION | | | | |
| | | | AND DISPERSION | | | | |
| | | | DEVICE | | | | |
| | ROTA- | (rpm) | 7,200 | — | — | — | — |
| | TION | | | | | | |
| | SPEED | | | | | | |
| | PRO- | (min) | 60 | — | — | — | — |
| | CESSING | | | | | | |
| | TIME | | | | | | |
| STEP | DRYING | (° C.) | 120 | 120 | 120 | 120 | 120 |
| (II) | TEMPER- | | | | | | |
| | ATURE | | | | | | |
| | DRYING | (hr) | 5 | 5 | 5 | 5 | 6 |
| | TIME | | | | | | |

| | | | | | | | |
|---|---|---|---|---|---|---|---|
| INOR- | BULK | (g/cm³) | 0.56 | 0.19 | 0.18 | 0.35 | 0.24 |
| GANIC | DENSITY | | | | | | |
| POWDER | TAPPED | (g/cm³) | 0.67 | 0.28 | 0.29 | 0.71 | 0.54 |
| PRO- | DENSITY | | | | | | |
| PERTIES | HAUSNER | (—) | 1.20 | 1.47 | 1.65 | 2.05 | 2.22 |
| | RATIO | | | | | | |
| | AVERAGE | (μm) | 0.40 | 0.62 | 10.0 | 0.30 | 0.40 |
| | PARTICLE | | | | | | |
| | DIAMETER | | | | | | |
| | (D50) | | | | | | |
| | SPECIFIC | (m²/g) | 11.2 | 13.0 | 9.0 | 10.8 | 11.2 |
| | SURFACE | | | | | | |
| | AREA | | | | | | |
| | O_{1S} SEMI- | (—) | — | 0.4 | 1.8 | — | — |
| | QUANTI- | | | | | | |
| | TATIVE | | | | | | |
| | VALUE | | | | | | |

| | | | | | | |
|---|---|---|---|---|---|---|
| FLUIDITY EVALUATION | (—) | A | D | D | D | D |

As shown in Table 2, the inorganic powders in Examples 1-7 having a Hausner ratio of 1.00-1.33 had excellent fluidity. It can be understood that the inorganic powders in these examples have improved fluidity compared to the raw material powders. Meanwhile, the inorganic powders in Comparative Examples 1-4, which do not satisfy the configuration of the present invention, had poorer fluidity evaluation than those of the examples. From the above results, it was confirmed that the inorganic powder according to the present embodiment can achieve excellent fluidity when blended in a resin.

### INDUSTRIAL APPLICABILITY

The inorganic powder according to the present embodiment can provide a resin composition having excellent fluidity. Therefore, the inorganic powder can be preferably used as a resin filler.

1. An inorganic powder having a Hausner ratio of 1.00-1.33.

2. The inorganic powder according to claim 1, wherein the inorganic powder has an average particle diameter (D50) of 30 μm or less.

3. The inorganic powder according to claim 1, wherein the inorganic powder has a specific surface area of 0.3 m²/g or more.

4. The inorganic powder according to claim 1, wherein the inorganic powder comprises at least one selected from an alumina powder, an aluminum nitride powder, a silica powder, a silicon nitride powder, a magnesium oxide powder, a titanium oxide powder, a zirconia powder, a zinc oxide powder, an aggregated boron nitride powder, a scaly boron nitride powder, and a spherical boron nitride powder.

5. The inorganic powder according to claim 1, wherein the inorganic powder is at least one selected from an aggregated boron nitride powder, a scaly boron nitride powder, and a spherical boron nitride powder.

6. The inorganic powder according to claim 5, wherein the inorganic powder has a semi-quantitative value, calculated from an O₁ₛ peak intensity measured by X-ray photoelectron spectroscopy, of 0.6 or more.

7. The inorganic powder according to claim 1, wherein the inorganic powder is for filling a resin.

8. A resin filler comprising the inorganic powder according to claim 1.

9. A resin composition comprising: the inorganic powder according claim 1; and at least one resin selected from the group consisting of a thermoplastic resin and a thermosetting resin.

10. A production method for the inorganic powder according to claim 1, the production method comprising:
dispersing a raw material powder into a liquid containing cavitation bubbles; and
recovering the raw material powder from the liquid and then drying the recovered raw material powder.

11. The production method according to claim 10, wherein the dispersing comprises loosening, with the cavitation bubbles, aggregated particles in the raw material powder.
